(19) United States
(12) Patent Application Publication
(10) Pub. No.: US 2016/0328219 A1
(43) Pub. Date: Nov. 10, 2016

(54) MOBILE APPLICATION DEVELOPMENT COLLABORATION SYSTEM

(71) Applicant: Microsoft Technology Licensing, LLC, Redmond, WA (US)

(72) Inventors: Arif Kureshy, Snohomish, WA (US); Alex Samoylenko, Redmond, WA (US)

(21) Appl. No.: 14/706,106

(22) Filed: May 7, 2015

(51) Int. Cl. G06F 9/44

(52) U.S. Cl. CPC G06F 8/38; G06F 8/35

(57) ABSTRACT

A mobile application development system is provided. The mobile application development system includes a user interface component configured to generate a user interface and receive mobile application template information. The mobile application template information includes a visual specification of the mobile application template and at one least hook-point configured to be coupled to a data source. A template store is configured to store the mobile application template information.

### BACKGROUND

Mobile devices are ubiquitous and allow users to interact with a wide array of information sources. Such sources range from news outlets and social media to confidential enterprise resources. Typically, a mobile application is generated by a developer who targets a specific mobile device platform and creates an application, or “app”, that is compiled and provided to a mobile application marketplace for consumption by users. For applications that target enterprise resources, the application may be generated and published to an enterprise execution framework such that various authorized users can execute the application on their respective mobile devices.

The discussion above is merely provided for general background information and is not intended to be used as an aid in determining the scope of the claimed subject matter.

### SUMMARY

A mobile application development system is provided. The mobile application development system includes a user interface component configured to generate a user interface and receive mobile application template information. The mobile application template information includes a visual specification of the mobile application template and at one least hook-point configured to be coupled to a data source. A template store is configured to store the mobile application template information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a computing system with which embodiments described herein are particularly useful.

FIG. 2 is a diagrammatic view of a development environment in accordance with one embodiment.

FIG. 3 is a diagrammatic view of a mobile application template in accordance with one embodiment.

FIG. 4 is a diagrammatic view of a development environment operating in a non-technical mode, in accordance with one embodiment.

FIG. 5 is a diagrammatic view of data binding relative to a mobile application template in accordance with one embodiment.

FIG. 6 is a diagrammatic view of relative roles and abilities for collaboration in the development of mobile applications, in accordance with one embodiment.

FIG. 7 is a diagrammatic view of various templates for mobile applications, in accordance with one embodiment.

FIG. 8 is a diagrammatic view of a mobile application configured by a non-technical user, in accordance with one embodiment.

FIG. 9 is a flow diagram of a method of generating a mobile application using collaboration between a developer and a non-developer in accordance with one embodiment.

FIG. 10 is a diagrammatic view of a cloud-computing environment with which embodiments described herein can be practiced.

FIG. 11 is a diagrammatic view of a mobile device with which embodiments described herein are particularly useful.

FIGS. 12 and 13 are additional diagrammatic views of other mobile devices which can be used in accordance with various embodiments.

FIG. 14 is a diagrammatic view of an exemplary computing system with which embodiments described herein can be practiced.

### DETAILED DESCRIPTION

Generating mobile applications for use with a variety of data sources, including proprietary data sources, has been limited. Fully custom mobile applications built by developers are difficult to customize, while modeled applications, which are easier to customize, have limited functionalities and visualizations. Thus, developers and non-developers alike are generally forced to make a choice and accept the associated limitations of that choice. Embodiments described herein generally provide a hybrid development model in which developers and non-developers each play an important role in order to provide highly customizable mobile applications.

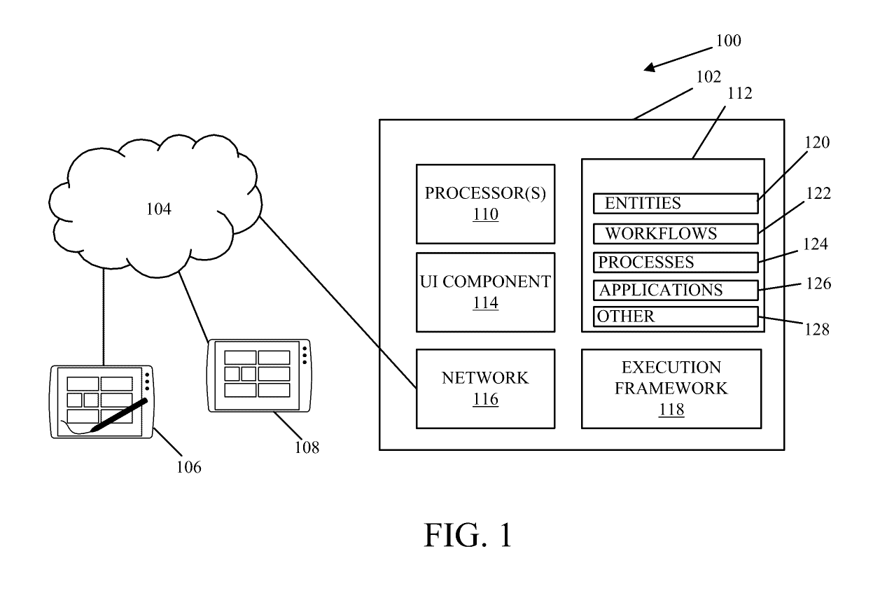

FIG. 1 is a diagrammatic view of a computing environment with which embodiments described herein are particularly useful. Environment 100 generally includes a data system, such as data system 102, coupled to a plurality of mobile devices 106, 108 via a communication network, such as a wide area network 104. Computer system 102 includes processor(s) 110, data store 112, user interface component 114, network component 116, and application execution framework 118. Data store 112 may include one or more data storage structures that are configured to store any suitable data relative to the function of computer system 102. In one example, computer system 102 may be a business system, such as an enterprise resource planning (ERP), a customer relationship management (CRM) system, and a line-of-business (LOB) system, among others. In one embodiment, data store 112 may be configured to store entities 120, workflows 122, processes 124, and applications 126, and any other suitable information 128. Entities component 120, in one embodiment, describes entities within system 102. For example, a customer entity describes and defines a customer. A vendor entity describes and defines a vendor. An inventory item entity describes and defines an item of inventory. The listing set forth above is provided as a non-limiting example of various entities that can be defined within system 102.

Workflows 122 and processes 124, in one example, operate on data entities 120 as well as any other suitable records 128 within data store 112 to enable a user to perform his or her operations within system 102. In one example, user interface component 114, either by itself, or under the control of other items within system 102, generates user interface displays on mobile devices 106, 108.

Applications 126 can be any suitable applications, such as applications which are configured to execute upon one or more of mobile devices 106, 108. Additionally, or alternatively, applications 126 may execute within execution framework 118 such that the result of such execution is provided via user interface component 114 to mobile devices 106, 108 via network connection 104.

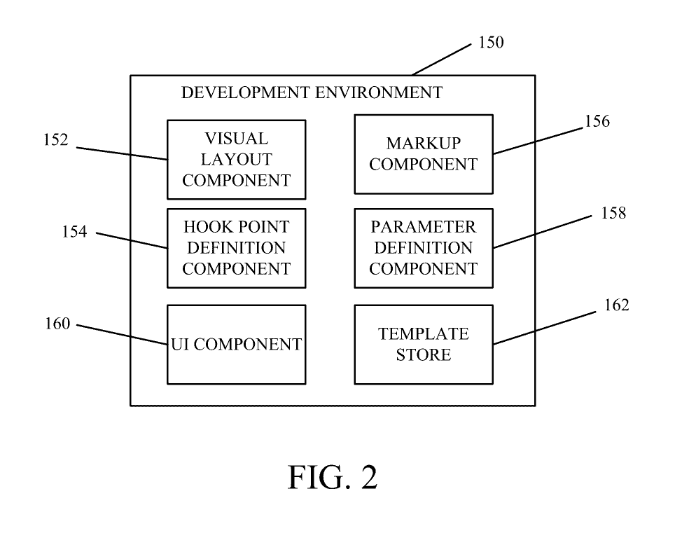

FIG. 2 is a diagrammatic view of a development environment configured for interaction with a mobile application developer in order to create one or more mobile application templates in accordance with embodiments described herein. Mobile application development environment 150 includes a visual layout component 152 that allows the developer to define the visual layout of an application template. Additionally, mobile development environment 150 also includes hook-point definition component 154. Hook-point definition component 154 allows the developer to create one or more hook-points for the mobile application template under development.

Mobile application development environment 150 also includes markup component 156 that allows the developer to generate and store markup information relative to the mobile application template under development. Finally, mobile application development environment 150 includes parameter definition component 158 that allows the developer to define or otherwise set various parameters relative to the mobile application template under development.

Mobile application development environment generally surfaces the various components 152, 154, 156, and 158 via a user interface component 160 to a developer. The developer interacts with mobile application development environment 150 via user interface component 160 in order to create one or more mobile application templates. Once such templates are created, they are saved in template store 162, in one embodiment.

In accordance with various embodiments, mobile applications are created in at least two distinct steps with different technical expertise requirements for each step. First, a developer, with relatively higher technical knowledge of the system upon which the mobile application will execute, defines one or more mobile application templates that set forth an application visualization. Then, a non-technical user will bind the mobile application template(s) created by the developer to various data entities, such as entities 120, in order to create a fully functional mobile application. In one example, the developer has the full capabilities of a modern development environment, such as development environment 150 to define the various visualizations. The non-technical developer then consumes the one or more templates stored in template store 162 using a browser-based point and click approach or a wizard-based tool. In either instance, the technical requirements on the non-technical are vastly reduced in comparison to the technical requirement on the developer. This allows for highly customizable mobile applications to be provided with relative ease, thereby increasing the efficiency of both the technical developer and the non-technical user.

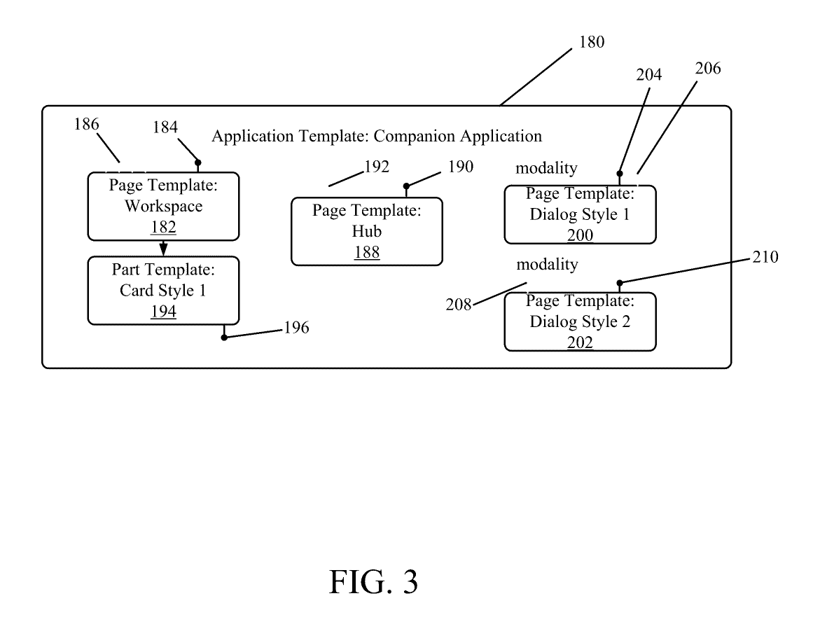

FIG. 3 is a diagrammatic view of a mobile application template generated by a technical developer in accordance with one embodiment. Application template 180 has been defined by the technical developer to have a particular visual layout and various customization points. In particular, application template 180 includes workspace template portion 182 that may include page templates, markup information, and template parameters. Page templates defined in workspace template portion 182, in one embodiment, have a root entity binding by default. This root entity binding is illustrated at reference numeral 184. Additionally, page templates defined in workspace template 182 also, in one embodiment, have create, read, update, and delete (CRUD) hook-points 186 by default. The markup of workspace template 182 can include, for example, a list control with cards; a background image; a chart; and/or an aggregate count. Additionally, template parameters defined relative to workspace template portion 182 can include card binding; background image binding; chart query binding; and aggregate count binding.

Application template 180 may also be defined by the technical developer to include a hub template portion 188. Hub template portion 188, in one embodiment, is defined to have a root entity binding, 190, by default. Further, hub template portion 188 may also include, by default, CRUD hook points 192. In one example, the technical developer may change the context on the hook points based on the ultimate function of the application. For example, the technical developer may change the context on hook points 192 to the current Timesheet Line context instead of a Timesheet context. Hub template portion 188 may also be defined, by the technical developer, to include certain markup information, such as HTML markup via markup component 156. Such markup can include, for example, a pivot control, such as information specifying that a first pivot is a grid; that the grid is grouped by a selector on the page; and that remaining pivot points can be bound to any part template. Further still, hub template portion 188 may also include hub template parameter information, such as information specifying a grid entity collection binding as well as the grid group by selector field binding.

The technical developer may further define any number of sub-templates and features relative to mobile application template 180. For example, the technical developer has defined a Card Style 1 template 194 having data binding 196, and being coupled to workspace template portion 182. Card style template 194 may include markup information, such as a card layout with any suitable number of distinct fields and template parameters, such as entity field bindings. Additionally, the technical developer may define any number of dialogs for the mobile application template. In the example shown in FIG. 3, for example, the technical developer has defined Dialog Style 1 template 200 and Dialog Style 2 template 202. In one example, Dialog Style 1 template 200 may include markup information suitable for small slider dialog markup as well as “OK” and “Cancel” buttons. Further, parameter information for Dialog Style 1 template 200 can include any number of entity field bindings, such as those indicated at reference numerals 204, 206. Similarly, Dialog Style 2 template 202 may include markup information such as that suitable for a large slider dialog markup. Further, the markup information may include “OK” and “Cancel” button information. Additionally, Dialog Style 2 template 202 may also include any number of entity field bindings 208, 210.

The example shown in FIG. 3 is merely illustrative of the various template components, markup, parameters, layouts, and bindings that a technical developer can define relative to a mobile application template. Note, once the technical developer has completed the mobile application template, generally none of the bindings are coupled to any data sources of the computer system.

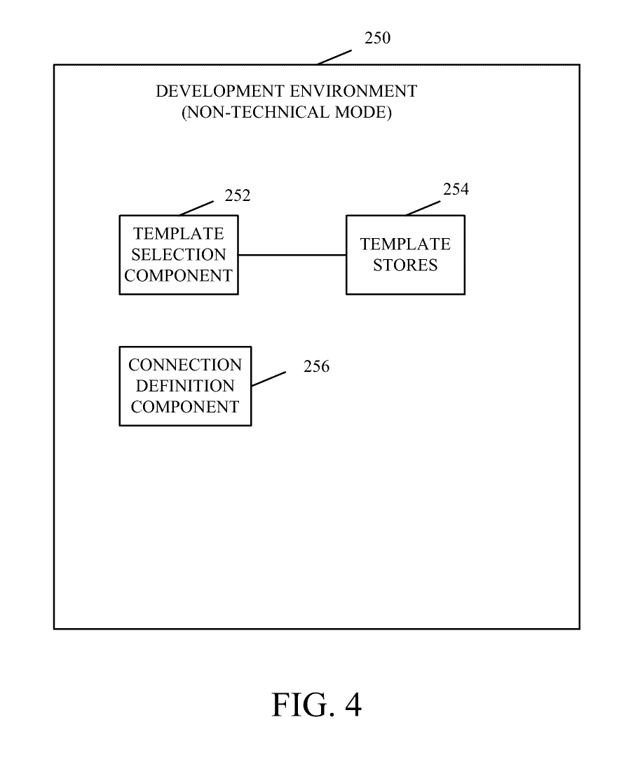

FIG. 4 is a diagrammatic view of a development environment suitable for a non-technical developer. Development environment 250 may be embodied within a commercially available web server/web client, or may be incorporated into a wizard or other suitable automation tool that is configured to guide a user through a process. Environment 250 generally includes a template selection component 252 that, upon actuation by a non-technical user, presents the user with a listing of one or more available mobile application templates. Thus, template selection component 252 is coupled, either directly or non-directly, to a source of such templates. This is shown, in FIG.4, at reference numeral 254. It should be noted that the templates stores 254 may be located on the same computing device as template selection component 252, or any other computing device that is communicatively coupled to the computing device upon which environment 250 executes. Regardless, template selection component 252 is configured to receive a template selection from a user and load, or otherwise engage, the mobile application template for further configuration by the non-technical user. Development environment 250 includes connection definition component 256 that allows the user to very easily couple any of the hook-points and/or data bindings of the loaded mobile application template to any suitable data entities or data sources of the computer system.

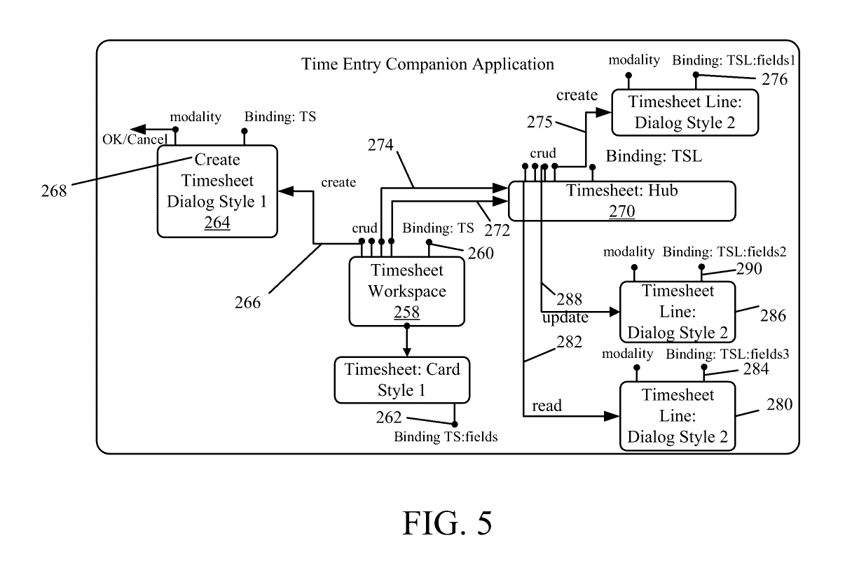

FIG. 5 is a diagrammatic view of a Time Entry Companion application being configured by a non-developer in accordance with one embodiment. As set forth above with respect to FIG. 4, the non-developer will generally browse or otherwise select a template via a non-technical development environment such as a web browser or wizard. In the example shown in FIG. 5, the non-developer has selected a Time Entry Companion Application template. The non-developer then instantiates, either directly or via the assistance of a wizard or another suitable non-technical development environment, a workspace page 258 and sets it as the startup or initial form. The non-developer then binds the timesheet entity as the page root entity. This is illustrated at reference numeral 260. Additionally, the non-developer may bind the background image of the workspace page 258 and may bind various timesheet fields to the card template embedded in the workspace page template. This is shown diagrammatically at reference numeral 262. Continuing on, the non-developer may then instantiate a Dialog Style 1 page, illustrated diagrammatically at reference numeral 264, and bind it to the create hook-point in the workspace page 258. This is illustrated diagrammatically at reference numeral 266. In one embodiment, the timesheet entity is then automatically bound as the context to the dialog page. The non-developer may then bind timesheet mandatory fields to dialog page 264, and may set the dialog caption as “create timesheet”, illustrated diagrammatically at reference numeral 268.

Next, the non-developer may instantiate a hub page 270 and bind it to the read and update hook-points 272, 274, respectively, in workspace page 270. In one embodiments, the timesheet entity is then automatically bound as the context to hub page 270. The non-developer may then bind the timesheet line entity collection from the page context [timesheet] to the grid on workspace page 258. In one embodiment, the non-developer then binds hub 270 to create hook-point 275 in hub page 270 (in one embodiment, hook-points have the timesheet line context as defined by the technical developer). The timesheet line entity, in one embodiment, is automatically bound as the context to the dialog page 276. The non-developer then binds the timesheet line mandatory fields to the dialog page and sets the dialog caption as “Create timesheet line”, as appropriate.

Next, the non-developer instantiates a Dialog Style 2 page 280 and binds it to the read hook-point 282 in hub page 270 (in one embodiment, hook-points have the timesheet line context as defined by the technical developer). The timesheet line entity, in one embodiment, is automatically bound as the context to dialog page 280. The non-developer then binds all the timesheet line fields 284 to dialog page 280, as appropriate, and sets the dialog caption as “Timesheet line.”

Finally, the non-developer may instantiate a Dialog Style 2 page 286 and bind it to update hook-point 288 in hub page 270 (in one embodiment, hook-points have the timesheet line context as defined by the technical developer). The timesheet line entity is, in one embodiment, automatically bound as the context to dialog page 286. Further, the non-developer then binds all timesheet line fields to the dialog pages indicated at reference numeral 290. Finally, the non-developer sets the dialog caption to “Edit timesheet line.”

Once the non-developer has completed the configuration of the template, the mobile application is tested. If the application passes the requisite tests, the non-developer can easily publish the application. Once the application has published, users and roles that have the requisite access to the published application will see the new mobile application in their mobile application main menu. In some embodiments, an individual mobile application on each user's mobile device will execute a client application that is coupled to the enterprise system 102 and obtains a listing of available applications or functions for which the user is authorized to execute. Thus, when a non-developer has finished testing and publishing a mobile application, the mobile application becomes available in system 102 for execution by executing framework 118 to the various authorized mobile devices and roles.

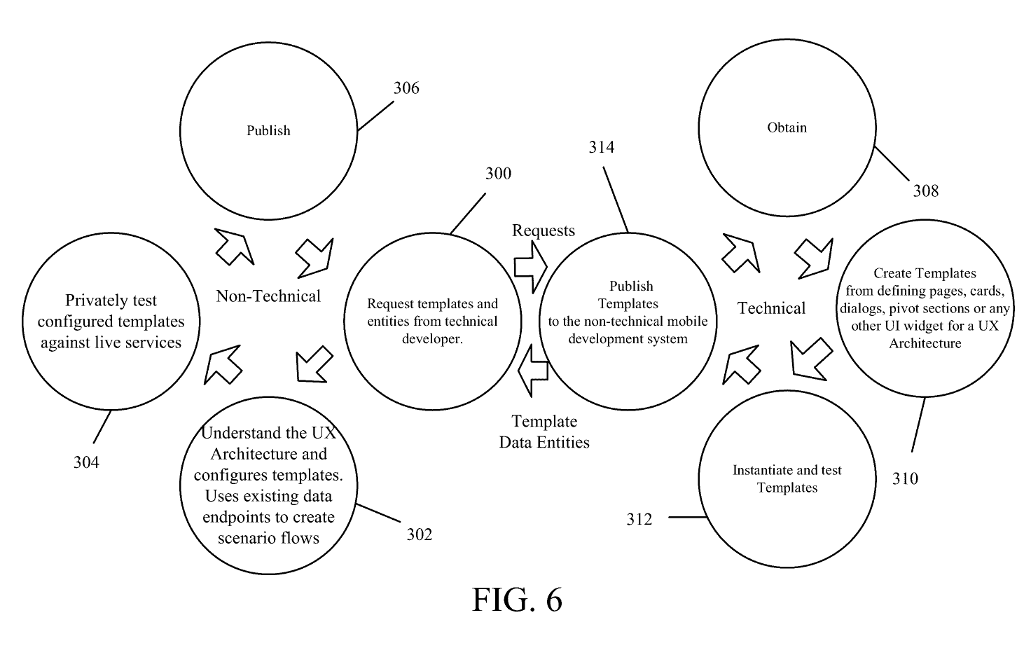

FIG. 6 is a diagrammatic view of various activities and interactions between the technical developer and the non-developer for collaborating on a mobile application in accordance with various embodiments. As indicated in FIG. 6, the technical developer will generally receive a request from a non-developer to define a mobile application template. Upon receiving the request, the technical developer may obtain previously created templates 308 or may create entirely new mobile application templates, as indicated at reference numeral 310. The mobile application templates may include definitions of pages, cards, pivot sections or any other user interface element for a user interface architecture. Once the template is created at reference numeral 310 by the technical developer, the template can be instantiated and tested using any suitable testing facilities, such as Microsoft's Visual Studio and ASP.Net MVC. This is indicated at reference numeral 312. Finally, once the tested mobile application template has passed the requisite tests, it may be published by the technical developer for further configuration by the non-technical developer. This is indicated at reference numeral 314.

The non-technical developer will typically obtain definitions for user interface architectures, and other suitable requirements for the mobile application from the technical developer. This is indicated diagrammatically at reference numeral 300. Next, the non-technical developer determines learns the user interface architecture and configures one or more mobile application templates based on such requirements. In one example, the non-technical developer will use existing data endpoints in order to create customized scenario flows, as indicated at reference numeral 302. Next, at reference numeral 304, the non-technical developer may privately test configured templates against live services and then publish, 306, the scenarios for other users by role or other grouping mechanisms. Once the published templates are available, the mobile application(s) will be available to users and/or roles that have proper access.

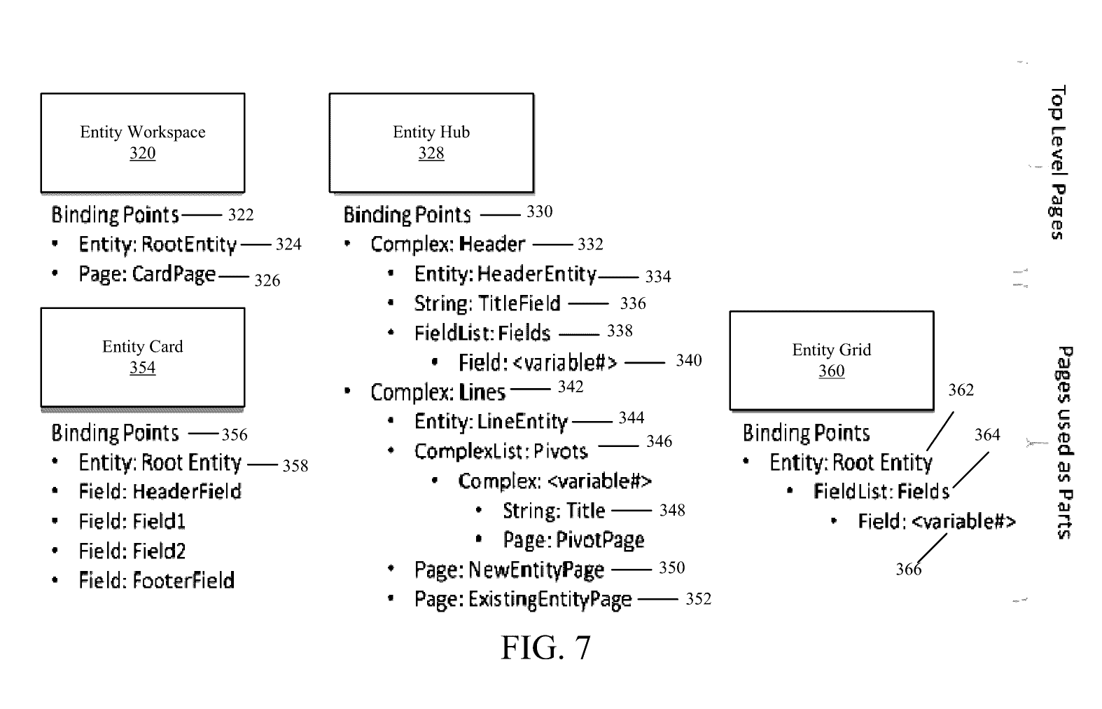

FIG. 7 is a diagrammatic view of various pages and parts used in a mobile application template in accordance with one embodiment. As shown in FIG. 7, an entity workspace 320 may include binding points 322 that specify an entity such as RootEntity 324 and a page, such as CardPage 326. Additionally, the mobile application template may include an entity hub 328 that sets forth a number of binding points 330. These binding points may include a complex binding point such as a Header 332 defining a HeaderEntity 334, TitleField 336, FieldList:Fields 338, and various fields 340. Additionally, a complex binding point of entity hub 328 may include a Lines binding point 342. Lines binding point 342 may specify a LineEentity 344, ComplexList:Pivots 346, and various complex variables 348. Further, the complex Lines binding point 522 may also specify various pages, such as NewEntityPage 350 and ExistingEntityPage 352. The mobile application template may also include one or more entity cards 354 which may specify binding points 356 and various entities and fields 358. Finally, an entity grid 360 may be supplied for the mobile application template. Entity grid 360 may have various binding points and may specify a RootEntity 362, a FieldList comprising fields 364 and various field variables 366.

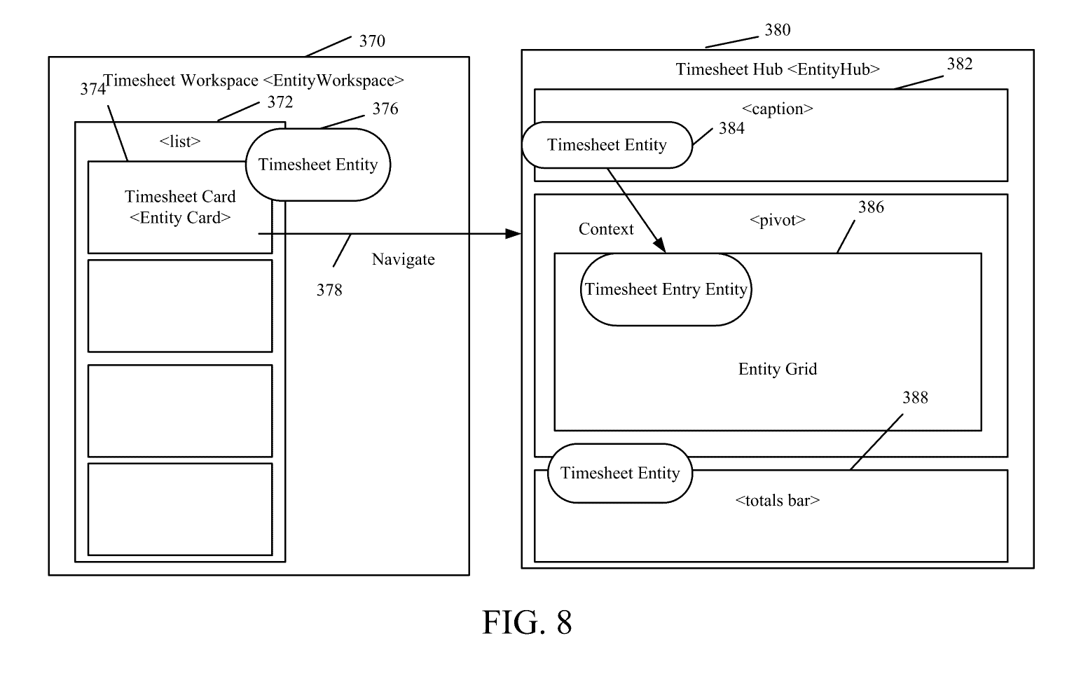

FIG. 8 is a diagrammatic view of an example mobile application template configured by a non-technical developer in accordance with one embodiment. As indicated in FIG. 8, the application includes a Timesheet workspace 370 having a list 372 and timesheet card 374. Additionally, a timesheet entity 376 is also provided. The non-technical developer then navigates, as indicated diagrammatically at reference numeral 378 to the timesheet hub 380. Timesheet hub 380 includes a caption 382, and a timesheet entity binding 384 bound to the caption, entity grid 386, and totals bar 388. The non-technical developer is able to simply insert and move various blocks of the template and couple hook-points and/or other bindings to suitable data sources as appropriate. In this way, a non-technical developer can easily perform the final configuration of the mobile application template and generate a finished mobile application for testing and publishing to the computer system.

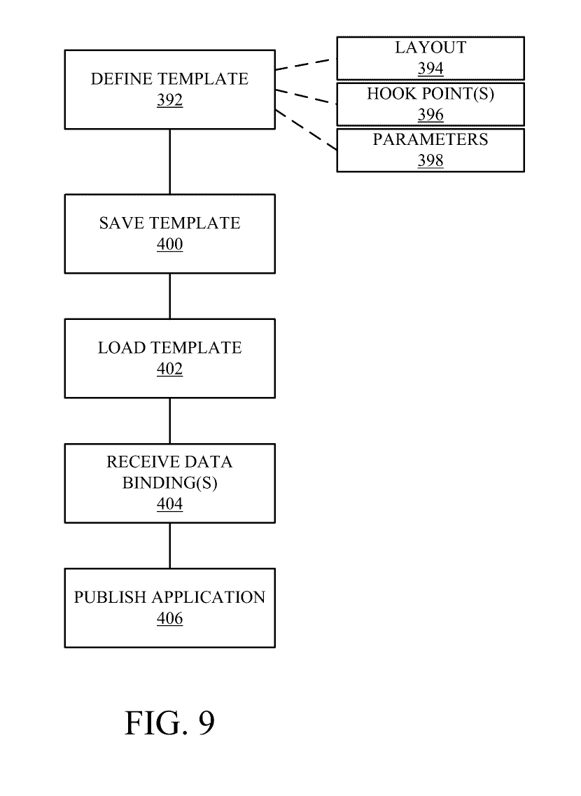

FIG. 9 is a flow diagram of a method of generating a mobile application in accordance with one embodiment. Method 390 begins a block 392 where a technical developer defines a mobile application template based upon one or more requirements. The defined mobile application template specifies a layout 394, hook-points 396, and various parameters 398 of the mobile application template. Once the technical developer has defined the mobile application template at block 392 it is saved at block 400. Then, the mobile application template is loaded or otherwise accessed by a non-technical user as indicated a block 402. The non-technical user then supplies various data binding information 404 relative to the mobile application template and publishes the application 406 for execution by one or more mobile devices.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

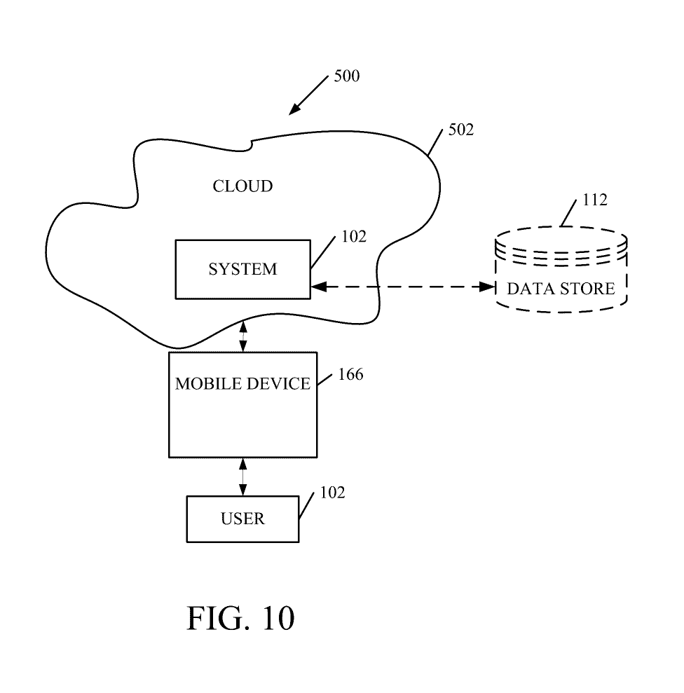

FIG. 10 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 10, some items are similar to those shown in FIG. 1 and they are similarly numbered. FIG. 10 specifically shows that computer system 102 located in cloud 502 (which can be public, private, or a combination where portions are public while others are private). Therefore, a user of mobile device 166 accesses system 102 through cloud 502.

FIG. 10 also depicts another embodiment of a cloud architecture. FIG. 10 shows that it is also contemplated that some elements of computer system 102 are disposed in cloud 502 while others are not. By way of example, data store 112 can be disposed outside of cloud 502, and accessed through cloud 502. Regardless of where they are located, they can be accessed directly by mobile device 166, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

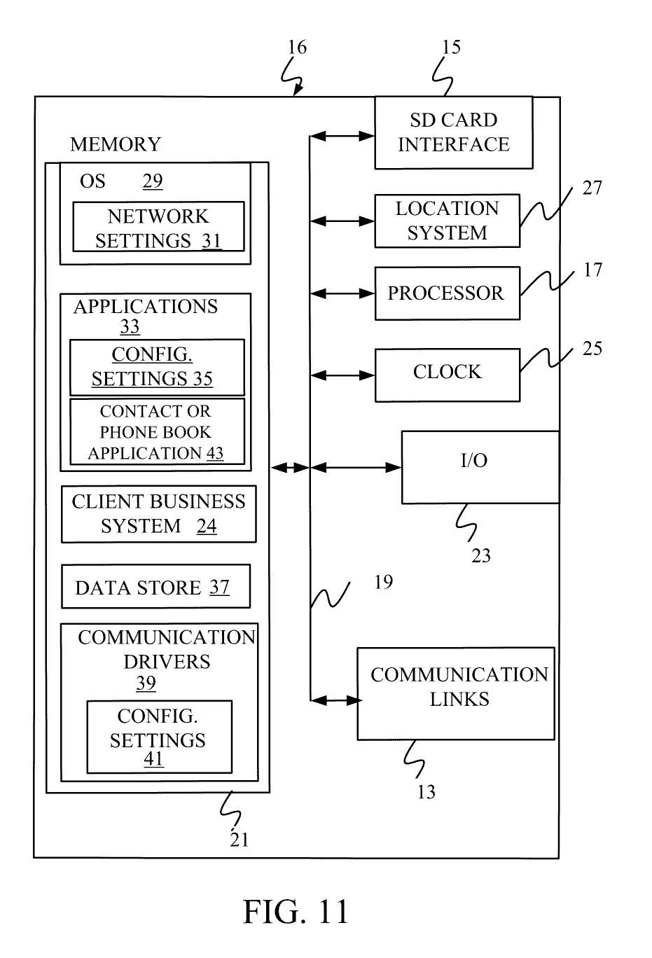

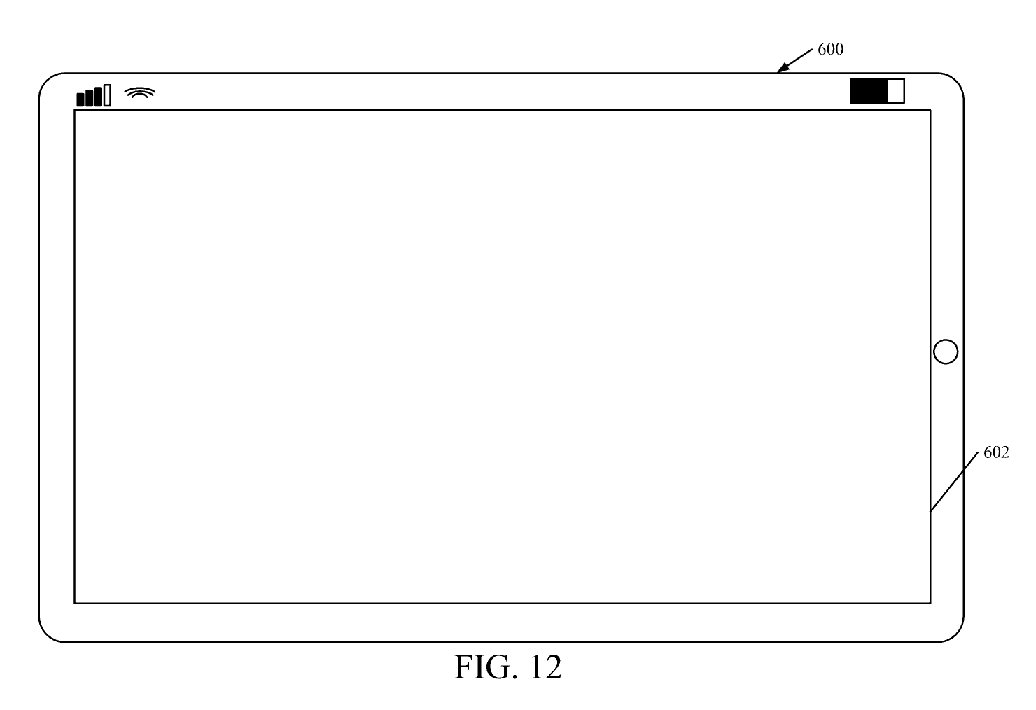

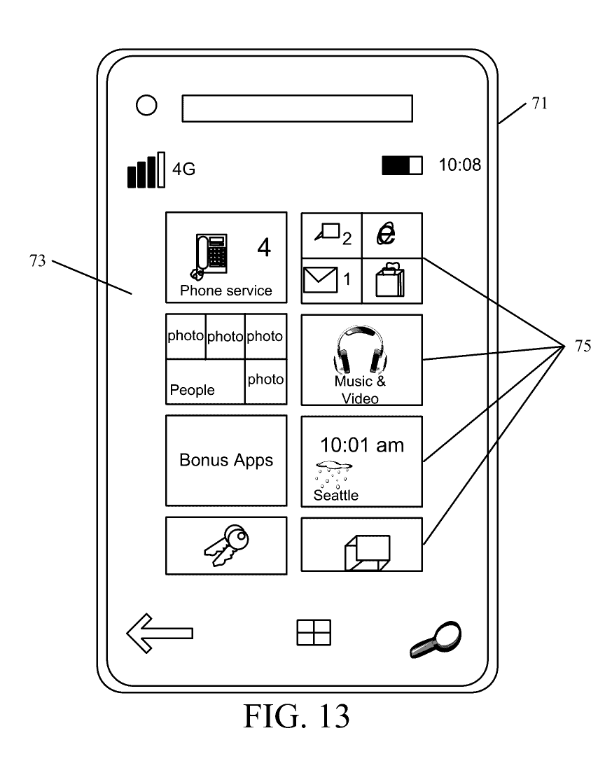

FIG. 11 is a simplified block diagram of one illustrative embodiment of a handheld or mobile computing device that can be used as a user's or client's hand held device 16, in which the present system (or parts of it) can be deployed. FIGS. 12 and 13 are examples of handheld or mobile devices.

FIG. 11 provides a general block diagram of the components of a client mobile device 16 that can run components of computer system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Device 16 can have a client application system 24 which can run various applications provided by execution framework 118 (shown in FIG. 1). Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 12 shows one embodiment in which device 16 is a tablet computer 600. In FIG. 12, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 13 provides an additional example of devices 16 that can be used, although others can be used as well. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

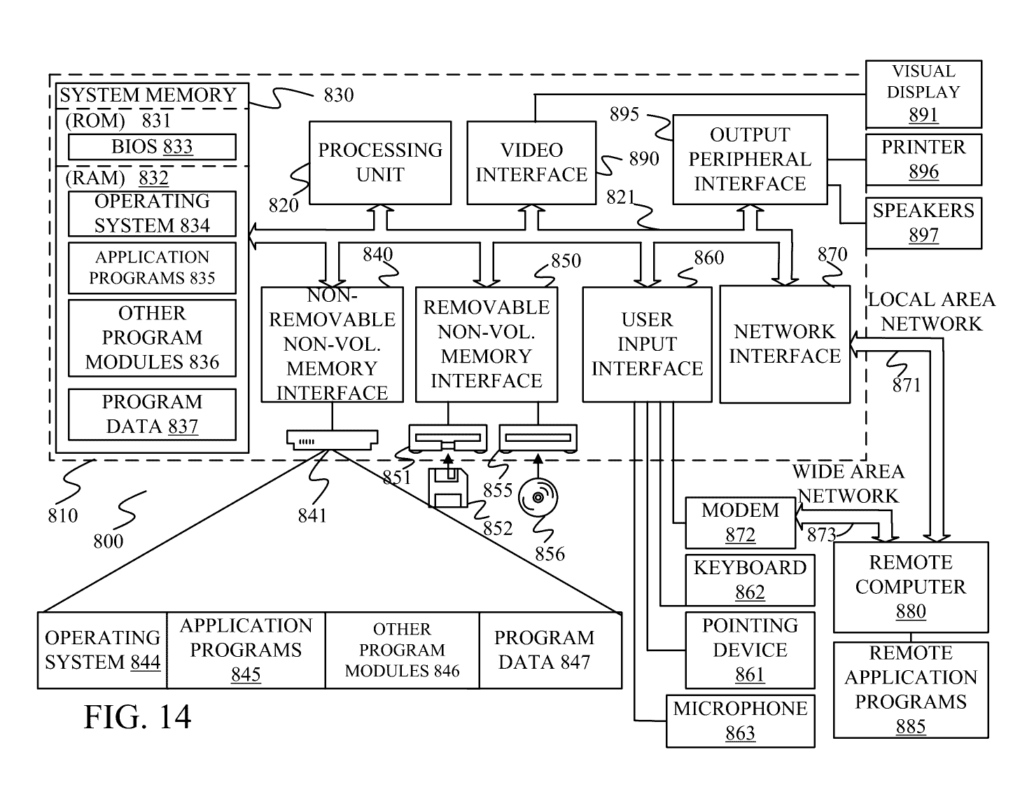

FIG. 14 illustrates one embodiment of a computing environment in which architecture 100, or parts of it, (for example) can be deployed. With reference to FIG. 14, an exemplary system for implementing some embodiments includes a general-purpose computing device in the form of a computer 810. Components of computer 810 may include, but are not limited to, a processing unit 820 (which can comprise processor 124, 186 or 190), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 14 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a mobile application development system. The mobile application development system includes a user interface component configured to generate a user interface and receive mobile application template information. The mobile application template information includes a visual specification of the mobile application template and at one least hook-point configured to be coupled to a data source. A template store is configured to store the mobile application template information.

Example 2 is the mobile application development system of any or all previous examples wherein the mobile application template information further comprises markup information.

Example 3 is the mobile application development system of any or all previous examples wherein the mobile application template information further comprises at least one parameter definition.

Example 4 is the mobile application development system of any or all previous examples wherein the mobile application template information further comprises a workspace template.

Example 5 is the mobile application development system of any or all previous examples wherein the mobile application template information further comprises a hub template.

Example 6 is the mobile application development system of any or all previous examples wherein the mobile application template information further comprises a card template.

Example 7 is the mobile application development system of any or all previous examples wherein the mobile application template information further comprises a dialog template.

Example 8 is the mobile application development system of any or all previous examples wherein the mobile application template information is accessible to a non-technical environment having a second user interface component configured to receive information indicative of at least one data source and bind the at least one hook-point to a respective at least one data source.

Example 9 is the mobile application development system of any or all previous examples wherein the data source is an entity.

Example 10 is the mobile application development system of any or all previous examples wherein the mobile application is configured to be executed by an execution framework once the at least one hook-point is bound to the respective at least one data source.

Example 11 is a mobile application development system including a template selection component and a connection definition component. The template selection component is configured to access at least one template store and provide an indication of available templates. The template selection component is further configured to receive a template selection and load a selected template. The connection definition component is configured to receive an indication of at least one data source to be bound to at least one respective hook points in the selected, loaded template.

Example 12 is the mobile application development system of any or all previous examples wherein the template selection component and the connection definition component are accessible via a web browser.

Example 13 is the mobile application development system of any or all previous examples wherein the template selection component and the connection definition component are accessible via a wizard.

Example 14 is the mobile application development system of any or all previous examples and further comprising a testing component configured to test the configured template.

Example 15 is the mobile application development system of any or all previous examples and further comprising a publishing system configure to publish the configured template for execution by at least one mobile device.

Example 16 is the mobile application development system of any or all previous examples wherein the configured template is configured to be executed by a server-side execution platform.

Example 17 is a computer-implemented method of generating a mobile application. The computer-implemented method includes defining a mobile application template and saving the mobile application template. The saved the saved mobile application template is then accessed with a non-technical development environment. At least one data binding is received via the non-technical development environment. The mobile application template is published as a mobile application after receiving the at least one data binding.

Example 18 is the computer-implemented method of any or all previous examples wherein the non-technical development environment is accessed via a web browser.

Example 19 is the computer-implemented method of any or all previous examples wherein the mobile application template definition includes layout information.

Example 20 is the computer-implemented method of any or all previous examples wherein the mobile application template definition include at least one hook-point.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile application development system comprising:
a user interface component configured to generate a user interface and receive mobile application template information, the mobile application template information including:
a visual specification of the mobile application template and at least one hook-point configured to be coupled to a data source; and
a template store configured to store the mobile application template information.

2. The mobile application development system of claim 1, wherein the mobile application template information further comprises markup information.

3. The mobile application development system of claim 1, wherein the mobile application template information further comprises at least one parameter definition.

4. The mobile application development system of claim 1, wherein the mobile application template information further comprises a workspace template.

5. The mobile application development system of claim 1, wherein the mobile application template information further comprises a hub template.

6. The mobile application development system of claim 1, wherein the mobile application template information further comprises a card template.

7. The mobile application development system of claim 1, wherein the mobile application template information further comprises a dialog template.

8. The mobile application development system of claim 1, wherein the mobile application template information is accessible to a non-technical environment having a second user interface component configured to receive information indicative of at least one data source and bind the at least one hook-point to a respective at least one data source.

9. The mobile application development system of claim 8, wherein the data source is an entity.

10. The mobile application development system of claim 8, wherein the mobile application is configured to be executed by an execution framework once the at least one hook-point is bound to the respective at least one data source.

11. A mobile application development system comprising:
a template selection component configured to access at least one template store and provide an indication of available templates, the template selection component being further configured to receive a template selection and load a selected template; and
a connection definition component configured to receive an indication of a at least one data source to be bound to at least one respective hook point in the selected, loaded template.

12. The mobile application development system of claim 11, wherein the template selection component and the connection definition component are accessible via a web browser.

13. The mobile application development system of claim 11, wherein the template selection component and the connection definition component are accessible via a wizard.

14. The mobile application development system of claim 11, and further comprising a testing component configured to test the configured template.

15. The mobile application development system of claim 11, and further comprising a publishing system configure to publish the configured template for execution by at least one mobile device.

16. The mobile application development system of claim 15, wherein the configured template is configured to be executed by a server-side execution platform.

17. A computer-implemented method of generating a mobile application, the method comprising:
defining a mobile application template;
saving the mobile application template;
accessing the saved mobile application template with a non-technical development environment;
receiving at least one data binding via the non-technical development environment; and
publishing the mobile application template as a mobile application after receiving the at least one data binding.

18. The computer-implemented method of claim 17, wherein the non-technical development environment is accessed via a web browser.

19. The computer implemented method of claim 17, wherein the mobile application template definition includes layout information.

20. The computer-implemented method of claim 17, wherein the mobile application template definition include at least one hook-point.
